(19) United States
(12) Patent Application Publication
(10) Pub. No.: US 2014/0199449 A1
(43) Pub. Date: Jul. 17, 2014

(54) METHODS FOR EXTENDING THE SHELF LIFE OF PROCESSED CUCURBITA PEPO VEGETABLES

(71) Applicant: Andy Hernandez, Kalispell, MT (US)

(72) Inventor: Andy Hernandez, Kalispell, MT (US)

(21) Appl. No.: 14/155,253

(22) Filed: Jan. 14, 2014

Related U.S. Application Data
(60) Provisional application No. 61/752,374, filed on Jan. 14, 2013.

(51) Int. Cl. A23B 7/16

(52) U.S. Cl. CPC A23B 7/16
USPC 426/310

(57) ABSTRACT

Methods for extending the shelf life of processed cucurbita pepo plants are provided herein. A method may include sanitizing an exocarp of the C. pepo vegetable, cutting the whole C. pepo vegetable into fragments, allowing the fragments to excrete a protective coating so as to cover each of the fragments with the protective coating, packaging the fragments in an airtight manner, and chilling the packaged fragments to approximately at or below 34° F.

### CROSS-REFERENCE TO RELATED APPLICATIONS

This non-provisional U.S. patent application claims the priority benefit of U.S. Provisional Application Ser. No. 61/752,374, filed on Jan. 14, 2013, titled “Process for Extending the Shelf-Life of Squash”, which is hereby incorporated by reference herein in its entirety including all references cited therein.

### FIELD OF THE INVENTION

The present technology is directed generally to methods for improving the shelf-life of cucurbita pepo (C. pepo) vegetables, such as summer squash, zucchini, and other similar plants. The present technology extends the shelf life for chopped or otherwise processed C. pepo vegetables to up to fourteen days.

### SUMMARY OF THE PRESENT TECHNOLOGY

According to some embodiments, the present technology may be directed to method for processing a cucurbita pepo (C. pepo) vegetable. The method comprises: (a) cutting a whole C. pepo vegetable into fragments, the whole C. pepo vegetable being previously sanitized and dried; and (b) allowing, for a period of time, the fragments to excrete a protective coating so as to cover each of the fragments with the protective coating.

According to some embodiments, the present technology may be directed to a method for processing a cucurbita pepo (C. pepo) vegetable. The method comprises: (a) sanitizing an exocarp of the C. pepo vegetable; (b) cutting the whole C. pepo vegetable into fragments; (c) allowing the fragments to excrete a protective coating so as to cover each of the fragments with the protective coating; (d) packaging the fragments; and (e) chilling the packaged fragments to approximately at or below 34° F.

According to other embodiments, the present technology may be directed to a method for processing a vegetable or fruit. The method comprises: (a) sanitizing an outer surface of a fruit or vegetable; (b) drying the fruit or vegetable; (c) cutting the fruit or vegetable into fragments; (d) applying a protective coating to the fragments, the protective coating comprising cutin extracted from a plant selected from the genus cucurbita; (e) chilling the fragments to approximately 34° F.; and (f) shipping the fragments to market while the fragments are maintained at a temperature of between approximately 34° F. and 36° F., inclusive.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a flowchart of a method for processing a cucurbita pepo (C. pepo) vegetable, so as to extend a shelf-life of the vegetable.

FIG. 2 is flowchart of another method for processing a cucurbita pepo (C. pepo) vegetable, so as to extend a shelf-life of the vegetable.

FIG. 3 is a flowchart of a method for processing a fruit or vegetable.

FIGS. 4A and 4B collectively illustrate cross sectional views of a cut summer squash.

FIG. 5 illustrates the excretion of cutin from a cut portion of a summer squash.

### DESCRIPTION OF EXEMPLARY EMBODIMENTS

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Extending the shelf life of vegetables, such as zucchini and summer squash, using the present technology will meet the expanded food service industry and consumer demand for prepared vegetable food products. It will have a significant impact on the vegetable trade. With shifting population demographics, consumption of process fresh vegetables foods continues to show a growth trend. With increased dining away from home, fresh process products are playing an ever-increasing role in the United States' food service and retail sector. In 2006, 27 percent of fresh process produce in the United States was sold in the food service sector, while 73 percent was sold in retail. Fresh process produce sales increased in value from US$3.3 billion in 1999 to US$15.5 billion in 2007. The problem of meeting this huge demand for fresh process produce vegetables is the fact that significant production yield decays or spoils before reaching the dinner table of the consumer. Part of this spoilage results from distribution difficulties which result from handling, loading, transport and storage. Even routine shipping can cause extensive spoilage and economic loss with short shelf-life products.

Spoilage of summer squash occurs as a result of a variety of processes including microbiological decay, temperature problems, handling damage, and loss of integrity.

The present technology may be utilized to extend the shelf-life or cut cucurbita pepo (C. pepo) vegetables, and specifically the fruit of these plants. Examples of C. pepo vegetables include, but are not limited to squash, zucchini, and the like. More specifically, the present technology may allow for cutting or otherwise fragmenting the C. pepo vegetable into pieces such as cubing, dicing, slicing, julienning, and other similar cuts.

The present technology allows for long term (up to approximately 14 days) of cut C. pepo vegetables by utilizing natural protective chemicals within the plant to cover exposed surfaces of the fragments of the plant, thereby forming a protective coating which resists damage from bacterial, fungi, and other pathogens. Further, this protective coating allows the fragments to be stored at temperatures ranging from approximately 34° F. to 36° F., inclusive, and even lower to around the freezing point of squash, which is approximately 31.1° F. The coated cut fragments experience a reduction or elimination in chilling injuries, which are common in these plants when chilled to below 40° F.

As background, there are several groups within the cucurbita genus such as summer squash, which further includes cocozelle, crookneck, yellow straight neck, and zucchini—just to name a few. In general, squash may be divided into two large groups. Summer squash is typically picked at an immature stage and is eaten without removal of the seed or tissue from the seed cavity. Winter squash is characterized by a hard shell and mature seeds. Squash is a perishable food product and should not be stored longer than necessary. The typical shelf life of squash is about eight to about ten days.

A specific characteristic of summer squash is a very high respiration rate, this causes significant perishability. Zucchini and yellow straight neck squash fruit are very susceptible to water loss. They are picked at an early stage of growth with a poorly developed thin cuticle (epidermis, exocarp) which is easily damaged during harvesting and subsequent handling. Injuries include cuts, punctures, abrasions and scuffing. These injuries to the skin are serious problems leading to microbial decay and economic loss.

Summer squash is cultivated throughout the world and is available year-round. Green zucchini is the most popular and widely grown. It is also economically important in many geographic growing regions. The summer squash are picked at an immature stage and eaten without removal of seed or seed cavity tissue.

Respiration provides the energy using oxygen, which in combination with carbohydrates, releases carbon dioxide. To assist in controlling respiration, Modified Atmosphere Packaging (MAP) reduces the concentration of oxygen in the atmosphere and increases carbon dioxide which suppresses respiration.

Fruits are naturally packaged in an outer envelope called the cuticle (epidermis, exocarp). The structural component of the cuticle is a biological lipid called cutin (phenolic), which is made by the outermost layer of cells. These are known as the epidermal cells. Cutin is contained within the cell structure of the epidermal cells. It is a large insoluble substance made from small molecules which, in turn, are derived from cellular fat. This material is not a good waterproofing material. However, the cuticle is covered with a complex mixture of materials also generated by the epidermal cells from cellular fat. This is sometimes referred to as wax. Particles of cutin embedded in the wax, together make a highly impermeable barrier or invisible band-aide when released through cutting of the epidermis.

This invisible band-aide reduces water loss and helps block the entry of pathogenic fungi and bacteria. This material is released when mechanical or rough handling causes cuts or bruises on the exocarp (outer skin.) The material seals the injury and after several days at ambient temperature forms a dark scab.

The United Stated Department of Agriculture (USDA) recommends storing summer squash at a temperature of about 41° to about 50° F. and winter squashes at a temperature of from about 50° to about 55° F. Squash held at a reduced temperature, of from about 32° to about 40° F., will develop chilling injuries after a few days. The chilling injuries manifest themselves as yellowing, pitting and a wilting appearance.

The process (in some embodiments) comprises the steps of: (a) washing a whole squash about three times; (b) drying the squash to remove excess water; (c) cutting the whole squash into fragments; (d) allowing the squash's protective coating to seep out (e.g., excrete) of the fragments; (e) packaging the fragments in a container; (f) cooling the container of squash fragments to about 34° F.; (g) shipping the fragments to market while the container temperature is maintained at about 34° F.; and maintaining the temperature of the squash at a temperature of about 34° F. The protective coating of squash is a lipid layer that reduces water loss and helps block the entry of pathogens and fungi. The principle types of coatings are cutin, suberin, and waxes.

Cutin is a macromolecule, a polymer consisting of many long-chain fatty acids that are attached to one another by ester linkages, creating a rigid three-dimensional network. Cutin is formed from a ratio of approximately 16:0 and 18:1 fatty acids with hydroxyl or epoxide groups situated either in the middle of the chain or at the end opposite the carboxylic acid function.

Cutin is a principal constituent of the cuticle, a multilayered secreted structure that coats the outer cell walls of the epidermis on the aerial parts of all herbaceous plants. The cuticle is composed of a top coating of wax, a thick middle layer containing cutin embedded in wax (the cuticle proper), and a lower layer formed of cutin and wax blended with the cell wall substances pectin, cellulose, and other carbohydrates (the circular layer). It has been suggested that in addition to cutin, the cuticle may contain a second lipid polymer made up of long-chain hydrocarbons, which has been named cutin.

Waxes are not macromolecules, but rather complex mixtures of long-chain acyl lipids that are extremely hydrophobic. The most common components of waxes are straight-chain alkanes and alcohols of 25 to 35 carbon atoms. Long-chain aldehydes, ketones, esters, and free fatty acids are also found in waxes. The waxes of the cuticle are synthesized by epidermal cells. They leave those cells as droplets that pass through pores in the cell wall by an unknown mechanism. The wax that forms the outer coating of the cuticle often crystallizes in an intricate pattern of rods, tubes, or plates. Certain patterns of these microstructures enhance water repellency by increasing the roughness of the wax surface. This roughness prevents water from forming large contact areas with, and thus from adhering to, the already hydrophobic surface. Thus water droplets form instantly on contact and carry away contaminating particles, cleansing the plant's surface. This phenomenon was first described for the leaves of the leguminous lotus Lotus japonicus, (and for that reason it is sometimes referred to as the “lotus effect.”)

Suberin is a polymer whose structure is poorly understood. Like cutin, cuberin is formed from hydroxy or epoxy fatty acids joined by ester linkages. However, cuberin differs from cutin in that it has dicarboxylic acids, more long-chain components, and a significant proportion of phenolic compounds as part of its structure.

Suberin is a cell wall constituent found in many locations throughout the plant. We have already noted its presence in the casparian strip of the root endodermis, which forms a barrier between the apoplast of the cortex and the stele. Suberin is a principal component of the outer cell walls of all underground organs and is associated with the cork cells of the periderm, the tissue that forms the outer bark of stems and roots during secondary growth of woody plants. Suberin also forms at sites of leaf abscission and in areas damaged by disease or wounding.

Since summer squash have remained un-cut and unchanged during the growth period of fresh pre-cut packaged produce, they have missed the fastest growing category of “value added” in the foodservice and retail sector. Consumers will benefit with extended shelf life, food safety issues addressed, and improved quality of these two vegetables.

As mentioned above, the United States Department of Agriculture (USDA) guidelines clearly state that the optimum storage temperature for summer squash is 41 to 50 degrees for optimum shelf life. These temperature requirements have been the greatest obstacle to pre-cut innovation with respect to C. pepo vegetables. This present technology will allow, for example, summer squash to enter the standard 34 to 40 degree environment. The present technology will also mitigate spoilage, extend shelf-life, reduce waste and economic loss at the retail, food-service (restaurant), and consumer levels. It will also stimulate economic growth at the farm level as additional marketing opportunities will open in the “value added” category of fresh pre-cut packaged produce.

Summer squash are grown in the field and are harvested in five gallon plastic buckets. Each bucket holds approximately 25 pounds of produce. Once the buckets are filled, they are sent to a sorting and packing table located at the field. The summer squash is sorted by humans according to size, color, and defects. Once sorted, they are packed into cartons based on size. These cartons weigh approximately 25 pounds. This packing process has drawbacks. For example, punctures, cuts, bruising, and scuffs often occur on some of the summer squash. The product is then shipped to market on 52 foot refrigerated trailers at 41 to 50 degrees. This process has not changed in more than 50 years.

Retail and restaurant produce mangers purchase the above mentioned box of summer squash and will discard approximately 10% per carton upon arrival. This number can rise to as high as 25% if inventory sits for three to five days due to deterioration from the initial packing process. The discarded summer squash will have punctures, cuts, bruising, scuffs and an additional defect, decay. This discard is known as “shrink.”

Aging and deterioration are a continuous process. However, the rate of aging depends upon the item itself and the conditions under which it is held. Most fresh vegetables are near or at their prime when harvested. Squash and other C. pepo vegetable fruits are displayed in markets at ambient temperature under water spraying jets. These displays are a haven for bacteria growth. Further, the produce is freely handled by shoppers and sometimes dropped on the floor and placed back on the shelf.

In some embodiments, methods of the present technology used to process zucchini and yellow straightneck squash, the cuticle (epidermis, exocarp) is cut and immediately cutin is exposed and begins to exude from the exposed cut surfaces. Cutin will cover the cut surfaces, forming a protective layer that acts as the invisible barrier on the exposed areas.

Zucchini and yellow straight neck varieties may each suffer from a number of physiological and pathological disorders as well as postharvest defects. These shortcomings create significant economic loss at all consumer levels.

Summer squash are very susceptible to water loss. Shriveling (loss of water) may become evident with as much as a three percent weight loss. Summer squash skin is very tender. They can be injured by the slightest scratch, bruise or scuff. When the skin breaks, a serious source of water loss and microbial infection can occur at optimum storage temperature.

Careful handling is necessary at levels of harvest, packing, shipping point and distribution.

There are several pathological symptoms associated with summer squash. Different plant health problems can look quite similar especially in the squash family. Professional plant pathologists can struggle with a diagnosis based on symptoms. Therefore, protocols for correct diagnosis are based on signs of the pathogen. Signs are actual physical evidence of the occurrence of the pathogen in association with the unhealthy plant material. These include: (a) mycelium or mold growth; (b) conks and mushrooms; (c) fruiting bodies (e.g., reproductive structures of some fungi that are embedded in diseased tissue, often requiring a hand lens to see); (d) sclerotia; (e) rust, which is usually present on the stems; (f) bacterial ooze and specific odors, which may be associated with tissue macerations by certain pathogens

Increased decay caused by fungal and bacterial pathogens through skin injury or chilling stress can cause significant postharvest losses in summer squash. Common postharvest diseases include Alternaria rot, bacterial soft rot, fusarium rot, phythopthora rot, and rhizopus rot.

Alternaria rot can be especially pronounced on summer squash following chilling injury and appears as grey mold on the exocarp. Grey mold on zucchini is commonly found in household refrigerators and therefore discarded. This happens because home refrigerators are set at 34 to 38 degrees F.

Optimum storage conditions for C. pepo vegetables as established by the USDA specify that zucchini and yellow straight neck squash can be stored one to two weeks under optimum conditions. Squash should be cooled rapidly after harvest to the proper storage temperature of 41° F. to 50° F., and stored at 95% relative humidity. Temperatures below 41° F. cause severe chilling injury that reduces shelf life.

Symptoms of chilling injury include water-soaked pitting, Alternaria rot and decay. Surface pitting and decay also occur rapidly above 50 degree temperature.

Chilled summer squash has increased rates of water loss upon transfer to non-chilling temperature. For example: when the squash is removed from a chilled environment (retail cooler) and placed on the retail shelf at ambient temperature, water loss and respiration increase.

Summer squashes are perishable and should not be stored any longer than necessary. Squash may be held at temperatures of 32 to 40 degrees Fahrenheit for short periods. Exposure to temperatures this low for more than a few days will result in chilling injuries. Chilling will manifest itself as yellowing, pitting and general wilting in appearance.

As earlier stated, summer squash contains cutin; in combination with wax it is a clear material that acts as an invisible barrier or coating. This invisible carrier reduces water loss and helps block the entry of pathogenic fungi and bacteria. This material is released when mechanical process cuts or bruises from rough handling occur on the cuticle.

The post-harvest metabolism of fruits and vegetables functions very much like that of a human. While sleeping, humans burn fewer calories and lose less water than when awake. Once cut from the mother plant, the tissue, stem, and seeds will no longer have access to nutrients from the plant. However, if the fruit or vegetable is damaged during harvest, the metabolism increases significantly. The fruit or vegetable is now vulnerable and is fighting for survival in the new environment. The energy to keep them alive can only be taken from their own tissue from what has been stored up to that moment of harvest.

In accordance with the present technology, when prepared in a processing plant, the summer squash is mechanically cut or hand processed which releases the natural component, cutin. The released cutin covers the entire exposed cut surface areas of each fragment. The cutin acts as an invisible barrier that prevents bacteria and pathogens from entering. The cut summer squash product is placed in MAP and cooled to 34° F. environment. A shelf life of approximately 14 days is achieved if the cut fragments are maintained at a temperature around 34° F.

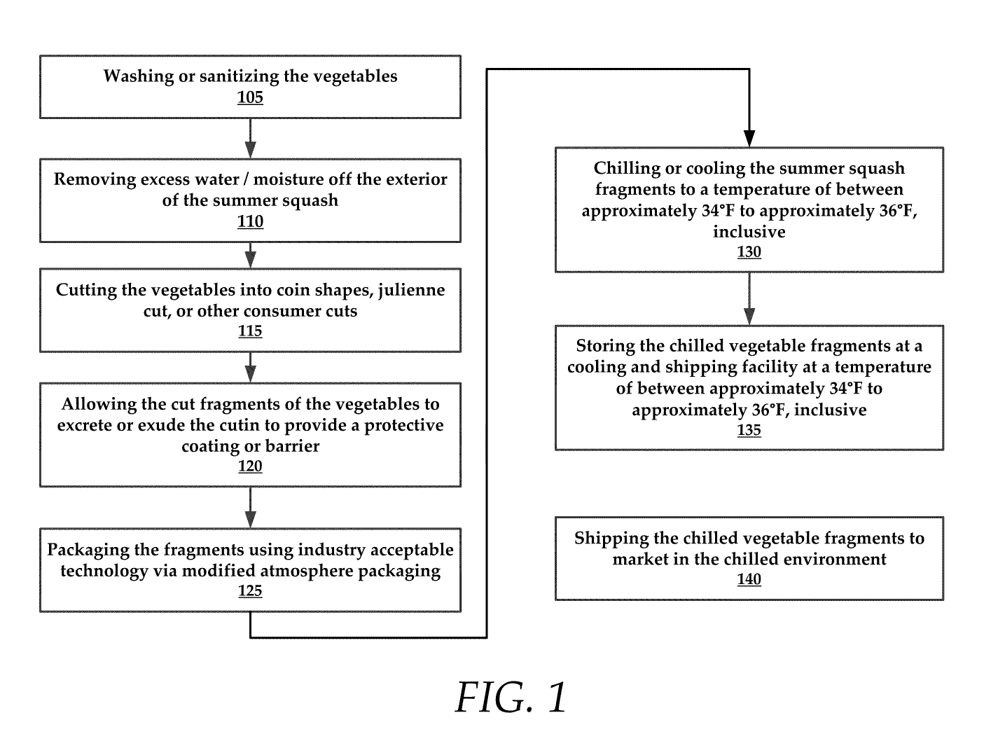

FIG. 1 illustrates an exemplary method for processing C. pepo vegetables such as zucchini and yellow straight neck squash. According to some embodiments, the method may be preceded by the harvesting process. In general, the harvesting process may include obtaining the zucchini and yellow straight neck squash (summer squash) from the field, which may include utilizing harvesting machines or manual labor. Next, the summer squash is gently placed in a plastic tray, significantly reducing cuts, bruising and stem punctures of the exocarp (e.g., outer layer or skin). Next, the harvesting process may include transporting the summer squash to a processing facility.

The method begins with a step of washing or sanitizing 105 the summer squash (or other desired vegetable) using a water wash system at ambient or cool temperature with 100 ppm chlorine or other wash systems, thereby removing all dirt or bacteria from the exocarp of the vegetables. It will be understood that the vegetables are washed or sanitized while whole (e.g., prior to cutting the vegetables into fragments or pieces).

In some embodiments, the vegetables are washed a plurality of times. For example, the vegetables may be washed three or more times to ensure that all bacteria, dirt, pathogens, fungi, and so forth are removed.

Next, the method includes removing 110 excess water/moisture off the exterior of the summer squash. This may be effectuated by using a drying mechanism or allowing the vegetables to air dry for a period of time.

In some embodiments, the method includes cutting 115 the vegetables into coin shapes, julienne cut, or other consumer cuts. The cutting of the vegetables exposes the flesh of the vegetables, allowing cutin to be released. Thus, the method includes allowing 120 the cut fragments of the vegetables to excrete or exude the cutin to provide a protective coating or barrier. Once the cutin has covered the exposed flesh of the fragments, the method includes packaging 125 the fragments using industry acceptable technology via modified atmosphere packaging. This may include sealing the bag hermetically to ensure that the packaging is airtight.

In some instances, the method includes chilling or cooling 130 the summer squash fragments to a temperature of between approximately 34° F. to approximately 36° F., inclusive. It will be understood that this chilling process is counter to the guidelines established by the USDA.

Next, the method includes storing 135 the chilled vegetable fragments at a cooling and shipping facility at a temperature of between approximately 34° F. to approximately 36° F., inclusive. In some embodiments, the method includes shipping 140 the chilled vegetable fragments to market in the chilled environment (as opposed to the traditional 41 to 50 degree environment specified by the USDA).

In general, it is preferable to maintain the vegetable fragments at a temperature that is within the above specified range (e.g., approximately 34° F. to approximately 36° F.) at all distribution levels.

It will be understood that the method of FIG. 1 extends the shelf-life of the chilled fragments for up to approximately 14 days for the new summer squash product.

This process technique and the release of Cutin and how it behaves as a functional barrier has allowed a temperature sensitive vegetables such as zucchini and summer squash to cross into the 34° F. environment and impact the USDA guidelines for summer squash.

By extending the shelf life of squash using this processing method it will meet the retail, food service industry, and consumer demand for fresh wholesome process vegetable food products.

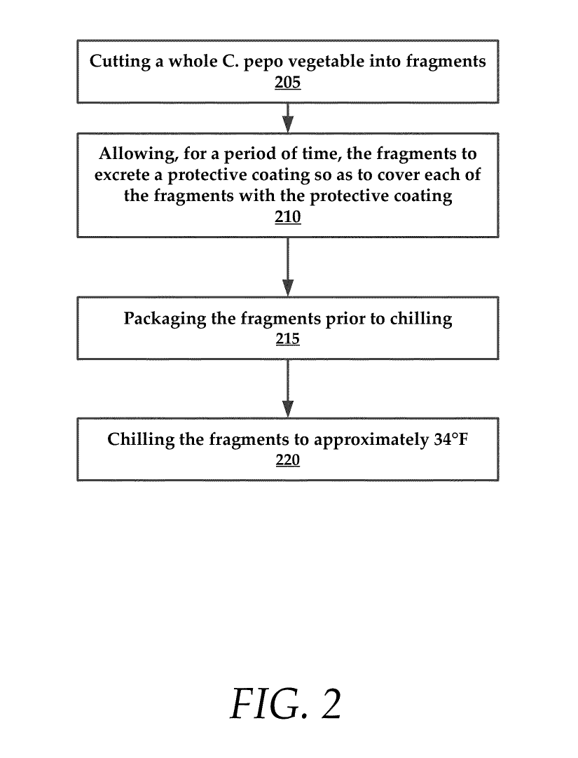

FIG. 2 is another exemplary method for processing C. pepo vegetables and extending the shelf-life thereof. In this embodiment, it will be understood that prior to execution of the method, the vegetables are preferably harvested, sanitized, and dried. The prior washed and dried vegetables are provided to a processor who executes the method of FIG. 2, which generally includes cutting 205 a whole C. pepo vegetable into fragments. The method also includes allowing 210 the fragments to excrete a protective coating so as to cover each of the fragments with the protective coating. This protective coating may include cutin, wax, suberin, or any combinations thereof, although the exact composition of the protective coating excreted will depend upon the vegetable utilized.

The step of allowing the fragments to excrete the protective coating may occur over a period of five minutes to thirty minutes, although the length of time required may depend on the amount of cutin present in the vegetable, as well as the efficacy with which the vegetable excretes cutin when cut.

The method may optionally include packaging 215 the fragments prior to chilling. Also, the method may include chilling 220 the fragments to approximately 34° F. This step may include chilling the fragments at a temperature of approximately 34° F. to approximately 40° F., for a period of up to 14 days, without inducing chilling injuries to the vegetable fragments.

Thus, the method may include maintaining, until customer purchase, the chilled fragments at a temperature that is between approximately 34° F. to approximately 40° F., inclusive, which includes all times during shipping, handling, and display at a market. Again, this extended shelf life is made possible by allowing cutin to excrete from the flesh of the vegetable and form a protective barrier. Thus, processes where cutin is not allowed to form a barrier (e.g., when vegetables are not allowed to sit for a period of time) or when vegetable fragments are washed after cutting, may not suffice as a protective barrier is not created using the cutin.

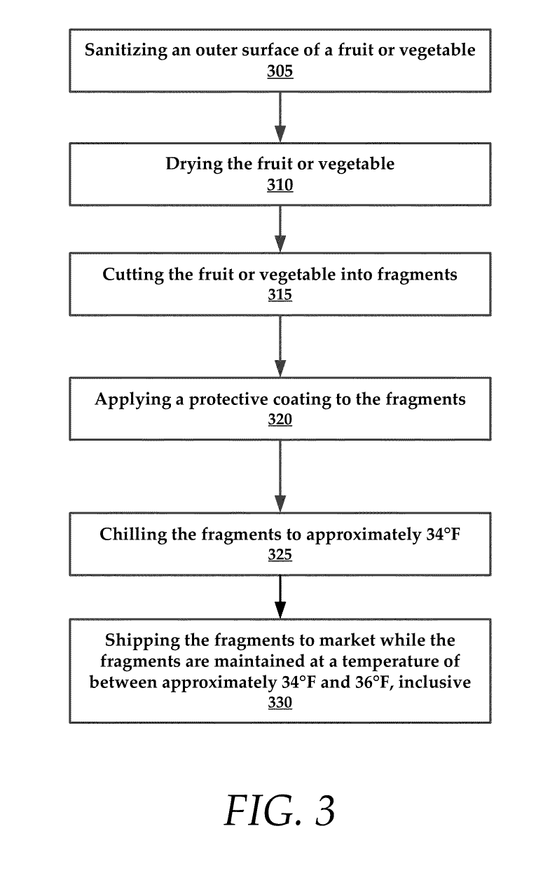

FIG. 3 is a flowchart of another method for processing a vegetable or fruit. While the above methods describe methods for processing and extending the life-span of C. pepo vegetabes, the cutin of a curcubita plant may also be utilized to provide a protective barrier for cut vegetables which are not naturally provided with (or only minimal amount) cutin inside their flesh. For example, tomatoes, potatoes, apples, pears, artichokes, and other vegetables and fruits may easily oxidize and turn colors when cut into fragments. This discoloration affects their desirability. Even when oxidation and discoloration are not a factor, exposure to pathogens, microbes, fungi and so forth are often a possibility when vegetables and fruit are pre-cut for consumers.

The method may include sanitizing 305 an outer surface of a fruit or vegetable and also drying 310 the fruit or vegetable.

In some embodiments, the method includes cutting 315 the fruit or vegetable into fragments and applying 320 a protective coating to the fragments. The protective coating comprises cutin extracted from a plant selected from the genus cucurbita. For example, cutin extracted from, for example, a summer squash, is sprayed on the fragments of the vegetables or fruit, thus creating a protective barrier on the cut surfaces of the vegetables or fruit. According to some embodiments, prior to the method of FIG. 3, cucurbita genus vegetables may be processed to remove or extract cutin therefrom. This may include steps such as cutting or otherwise processing the vegetables to extract and purify their cutin. This cutin extract may be sprayed or otherwise applied other vegetables or fruit.

The use of cutin to protect vegetables or fruit provides a benefit over other methods for preserving vegetables or fruit, such as the application or submerging of the cut fragments in acidulated water (e.g., lemon water). The use of acidulated water may introduce undesirable flavor characteristics to the vegetables or fruit.

In some embodiments, the method includes chilling 325 the fragments to approximately 34° F., and shipping 330 the fragments to market while the fragments are maintained at a temperature of between approximately 34° F. and 36° F., inclusive.

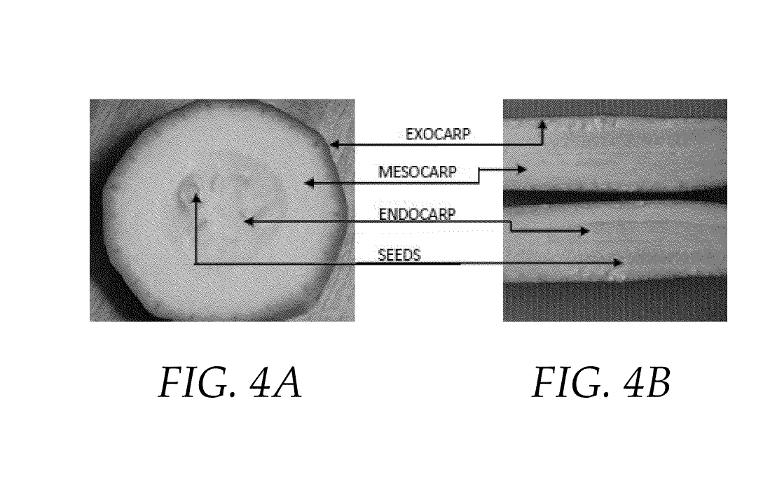

FIGS. 4A and 4B collectively illustrate cross sectional views of a cut summer squash. FIG. 4A is an end view of the summer squash and FIG. 4B is a side view of the summer squash, which has been sliced down the middle. The various layers of the squash can be seen clearly. These layers comprise the exocarp or outer layer of skin. Below the exocarp is the mesocarp and endocarp. The mesocarp comprises cellular components that comprise the cutin, wax, and suberin described above. The endocarp is in the core of the squash and provides a matrix for the seeds of the squash.

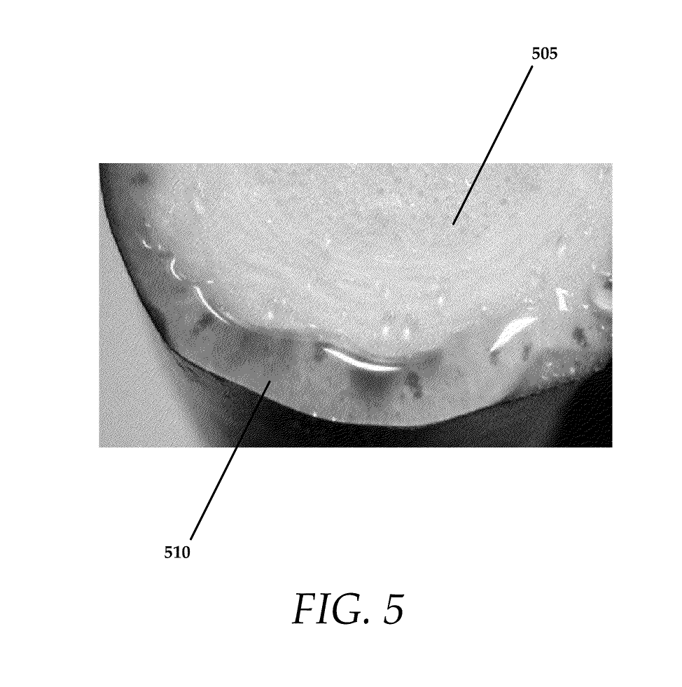

FIG. 5 is a perspective view of a summer squash 505 that has been cut to expose the mesocarp, endocarp, and seeds. This cutting of the squash causes the excretion of cutin 510 from the squash, which is shown as exuding from and pooling around squash proximate the mesocarp.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for processing a cucurbita pepo (C. pepo) vegetable, the method comprising:
cutting a whole C. pepo vegetable into fragments, the whole C. pepo vegetable being previously sanitized and dried; and
allowing, for a period of time, the fragments to excrete a protective coating so as to cover each of the fragments with the protective coating.

2. The method according to claim 1, further comprising chilling the fragments to approximately 34° F.

3. The method according to claim 2, further comprising packaging the fragments prior to chilling.

4. The method according to claim 1, further comprising shipping the fragments to market while the fragments are maintained at a temperature that is approximately 34° F.

5. The method according to claim 1, further comprising maintaining the fragments at approximately 34° F. until the fragments are sold to a consumer.

6. The method according to claim 1, wherein the protective coating comprises a natural coating that includes any of cutin, wax, suberin, or any combinations thereof.

7. The method according to claim 1, further comprising:
washing a whole C. pepo vegetable a predetermined number of times; and
drying the whole C. pepo vegetable.

8. The method according to claim 7, wherein the predetermined number of times includes three or more times.

9. A method for processing a cucurbita pepo (C. pepo) vegetable, the method comprising:
sanitizing an exocarp of the C. pepo vegetable;
cutting the C. pepo vegetable into fragments;
allowing the fragments to excrete a protective coating so as to cover each of the fragments with the protective coating;
packaging the fragments in an airtight manner; and
chilling the packaged fragments to approximately at or below 34° F.

10. The method according to claim 9, wherein sanitizing comprises washing the C. pepo vegetable in water having a specified temperature, the water comprising a sanitizer.

11. The method according to claim 10, wherein the sanitizer comprises chlorine, the chlorine being added to the water at 100 ppm (parts per million).

12. The method according to claim 10, wherein the specified temperature is ambient temperature or cooler than ambient temperature.

13. The method according to claim 9, further comprising drying the whole C. pepo vegetable prior to cutting.

14. The method according to claim 9, wherein packaging comprises placing the packaged fragments in a corrugated carton.

15. The method according to claim 9, further comprising shipping the chilled fragments to market while maintaining the chilled fragments at a temperature of between approximately 34° F. and 36° F., inclusive.

16. The method according to claim 15, further comprising receiving the chilled fragments; and maintaining, at the market, the chilled fragments at a temperature of between approximately 34° F. and 36° F., inclusive.

17. A method for processing a vegetable or fruit, the method comprising:
sanitizing an outer surface of a fruit or vegetable;
drying the fruit or vegetable;
cutting the fruit or vegetable into fragments;
applying a protective coating to the fragments, the protective coating comprising cutin extracted from a plant selected from the genus cucurbita;
chilling the fragments to approximately 34° F.; and
shipping the fragments to market while the fragments are maintained at a temperature of between approximately 34° F. and 36° F., inclusive.

18. The method according to claim 17, wherein the protective coating further comprises at least one of wax and suberin.
